(19) United States
(12) Patent Application Publication
(10) Pub. No.: US 2005/0274552 A1
(43) Pub. Date: Dec. 15, 2005

(54) Electric cart having a wireless control circuit device

(76) Inventor: Shao-Shih Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/853,187

(22) Filed: May 26, 2004

(51) Int. Cl. B60K 1/00

(52) U.S. Cl. 180/65.1

(57) ABSTRACT

An electric cart having a wireless control circuit device includes a governor, a transmitter, a receiver and a motor controller. The governor sends a signal to the transmitter. The transmitter transforms the signal into a digital signal (or an analog signal) and transmits a radio signal to the receiver. When receiving the radio signal, the receiver decodes the signal into an analog signal (or a digital signal) and transmits the signal to the motor controller to drive the motor. This design does not use a large amount of wiring, thus it is easy to disassemble.

### FIELD OF THE INVENTION

This invention relates to an electric cart having a wireless control circuit device, and more particularly, to one that uses the wireless control circuit device to activate the movement of the electric cart.

### BACKGROUND OF THE INVENTION

An electric cart is convenient to the elderly and some disable people for its mobility. However, in order to control the electric cart, a user needs to operate the cart through a panel. The panel is wired to a motor to control the movement of the electric cart. The wiring is so complicated that it can hardly be disconnected when the user wishes to travel or to transport the cart through a bus, a train, or an airplane.

### SUMMARY OF THE INVENTION

It is the primary object of the present invention to provide an electric cart having a wireless control circuit device, which saves the space of wiring.

It is another object of the present invention to provide an electric cart having a wireless control circuit device, which has less wiring and is easy to maintain.

It is a further object of the present invention to provide an electric cart having a wireless control circuit device, which is easy to operate.

### BRIEF DESCRIPTION OF THE DRAWINGS

FIG. 1 is a circuitry of a wireless control circuit device of the present invention;

FIG. 2 is a block diagram of the wireless control circuit device of the present invention; and

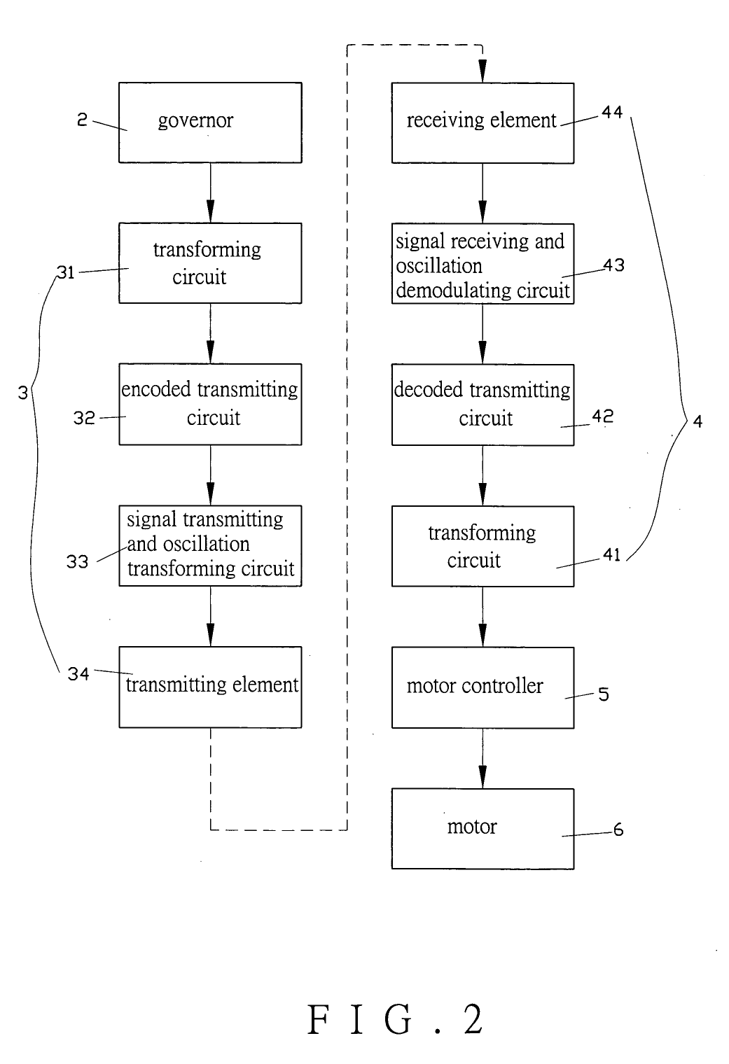

FIG. 3 is a side view of an electric cart incorporated with the present invention.

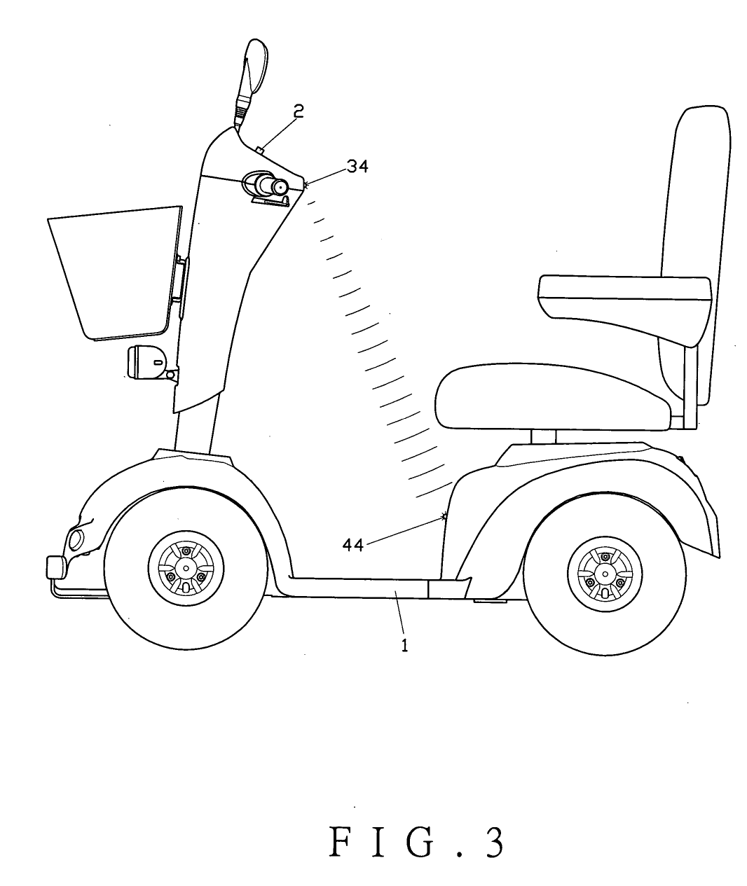

### DETAILED DESCRIPTION OF THE PREFERRED EMBODIMENT

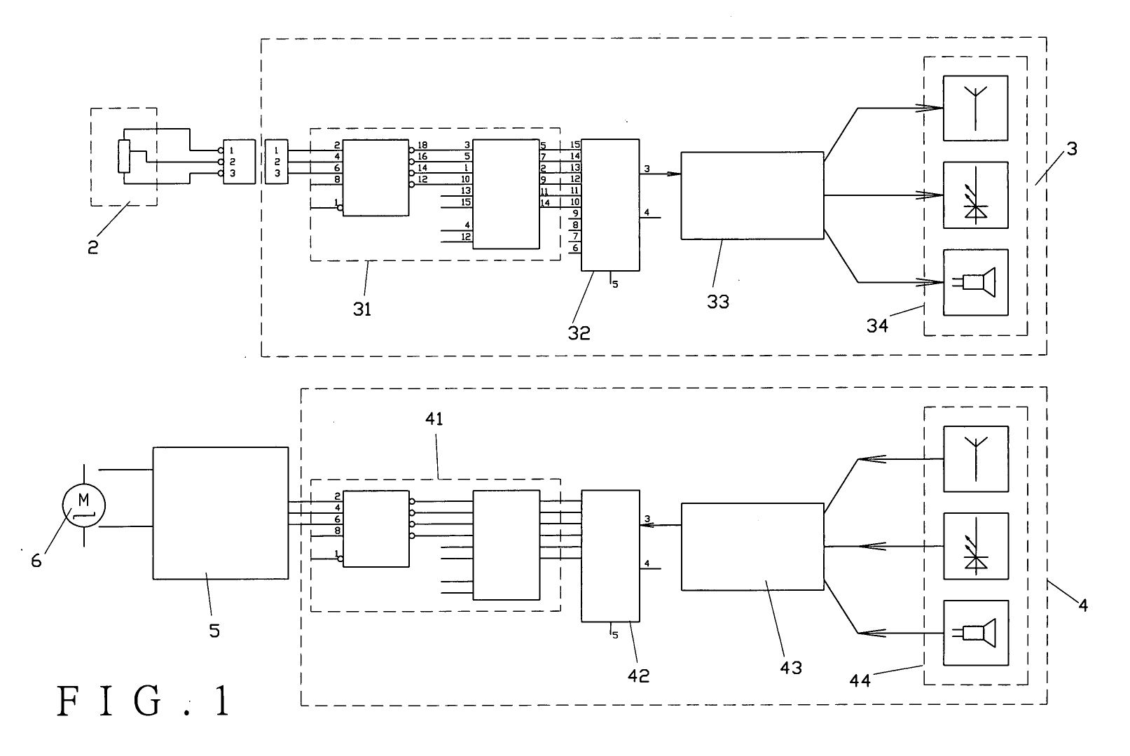

An electric cart 1 of the present invention, as shown in FIGS. 1˜3, comprises a wireless control circuit device which includes a governor 2, a transmitter 3, a receiver 4, and a motor controller 5.

The governor 2 may be an analog signal output part or a digital signal output part, such as a variable resistance, a variable capacitor, a Hau effect device, or a non-contact sensor. In this embodiment, a variable resistance is adapted as an example.

The governor 2 is equipped on the electric cart 1 and located in front of the transmitter 3. The governor 2 activates the transmitter 3 and controls the analog resistance signal to adjust the output rpm (revolutions per minute) of a motor 6.

The transmitter 3 comprises a transforming circuit 31, an encoded transmitting circuit 32, a signal transmitting and oscillation transforming circuit 33, and a transmitting element 34. The transforming circuit 31 transforms the input signal from the analog resistance signal into digital output signal. The encoded transmitting circuit 32 and the signal transmitting and oscillation transforming circuit 33 enhance the strength of the digital output signal, which is then transmitted through the transmitting element 34. The transmitting element 34 may be an infrared sensor, a radio antenna or a supersonic sensor to conduct the transmission.

The receiver 4 includes a transforming circuit 41, a decoded transmitting circuit 42, a signal receiving and oscillation demodulating circuit 43, and a receiving element 44. Upon the receiving element 44 receives the signal from the transmitter 3, the decoded transmitting circuit 42 and the signal receiving and oscillation demodulating circuit 43 will filter out any unnecessary noise from the received signal and then enhance the signal. The transforming circuit 41 transforms the signal from digital signal into analog resistance signal and outputs the signal.

The motor controller 5 is connected with the receiver 4 in order to receive the analog resistance signal from the receiver 4 to activate the motor 6.

To operate the present invention, the governor 2 is mounted on the electric cart 1. The governor 2 will output an analog resistance signal. The transmitter 3 transforms the analog resistance signal into digital signal, and then encodes the signal and outputs a radio signal. When receiving the radio signal, the receiver 4 decodes the signal and transforms the digital signal into an analog resistance signal to activate the motor controller 5 and to drive the motor 6. There is no necessary to wire the governor 2 and the motor controller 5. Thus, the electric cart 1 is easy to disassemble.

When disassembling the electric cart 1 of the present invention, there is no complicated wire design. Thus, bad connection or disconnection is out of consideration when disassembling the electric cart.

1. An electric cart having a wireless control circuit device comprising a governor, a transmitter, a receiver, and a motor controller, wherein:
said governor located in front of said transmitter controlling an output signal to activate said transmitter;
said transmitter comprising a transforming circuit, an encoded transmitting circuit, a signal transmitting and oscillation transforming circuit and a transmitting element;
said receiver comprising a transforming circuit, a decoded transmitting circuit, a signal receiving and oscillation demodulating circuit and a receiving element;
said motor controller connected with said receiver receiving the signal from the receiver to activate said motor;
by means of the output signal from said governor to said transmitter, said transmitter transforming and encoding the signal and transmitting a radio signal to said receiver, upon receiving the radio signal, said receiver decoding and transmitting the signal to said motor controller to activate said motor.

2. The electric cart having a wireless control circuit device, as recited in claim 1, wherein said transmitting element and said receiving element are infrared sensors.

3. The electric cart having a wireless control circuit device, as recited in claim 1, wherein said transmitting element and said receiving element are radio antennas.

4. The electric cart with wireless control circuit device, as recited in claim 1, wherein said transmitting element and said receiving element are supersonic sensors.
